(19) United States
(12) Patent Application Publication
(10) Pub. No.: US 2011/0117445 A1
(43) Pub. Date: May 19, 2011

(54) ELECTROLYTES FOR LITHIUM AND LITHIUM-ION BATTERIES

(75) Inventor: Daniel P. ABRAHAM, Bolingbrook, IL (US)

(73) Assignee: UChicago Argonne, LLC, Chicago, IL (US)

(21) Appl. No.: 12/910,549

(22) Filed: Oct. 22, 2010

Related U.S. Application Data
(60) Provisional application No. 61/261,961, filed on Nov. 17, 2009.

(51) Int. Cl. H01M 10/056

(52) U.S. Cl. 429/330; 429/342; 429/335; 429/329

(57) ABSTRACT

The present invention provides an electrolyte for lithium and lithium-ion batteries comprising a lithium salt such as LiF₂BC₂O₄, LiPF₆, LiBF₄, and/or LiB(C₂O₄)₂. In a liquid carrier comprising glycerol carbonate. Preferably, the electrolyte comprises a combination of glycerol carbonate with one or more other carbonate solvent (e.g., dimethylcarbonate, ethylene carbonate, and the like).

### CROSS-REFERENCE TO RELATED APPLICATIONS

This application claims the benefit of U.S. Provisional Patent Application Ser. No. 61/261,961, filed on Nov. 17, 2009, which is incorporated herein by reference in its entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to electrolytes for lithium and lithium-ion batteries. More specifically this invention relates to electrolytes comprising glycerol carbonate useful in lithium and lithium-ion batteries.

### BACKGROUND OF THE INVENTION

Recent advances in cathode and anode materials have refocused attention on electrolytes as the technological bottleneck limiting the operation and performance of lithium-battery systems. Attributes such as cell potential and energy density are related to the intrinsic property of the positive and negative electrode materials, while cell power density, calendar-life and safety are dictated by the nature and stability of the electrolyte and the electrode-electrolyte interfaces. A wide electrochemical window, wide temperature stability range, non-reactivity with the other cell components, non-toxicity, low cost, and a lithium-ion transference number approaching unity are, in general, desirable characteristics for lithium battery electrolytes. In addition, the electrolyte should have excellent ionic conductivity to enable rapid ion transport between the electrodes, and be an electronic insulator to minimize self-discharge and prevent short-circuits within the cell. Various carbonate solvents such as dimethylcarbonate (DMC), ethylmethylcarbonate (EMC), ethylene carbonate (EC), propylene carbonate (PC), and mixtures of two or more of such carbonates, have been utilized as a solvent for lithium salts in lithium batteries and lithium-ion batteries. Research on electrolytes and on functional electrolyte additives to improve cell life, thermal abuse behavior and low-temperature (e.g., <0° C.) performance of lithium-ion cells is ongoing.

### SUMMARY OF THE INVENTION

The present invention provides an electrolyte for lithium and lithium-ion batteries comprising a lithium salt in a liquid carrier containing glycerol carbonate (GC), which is a relatively nontoxic solvent with very low vapor pressure.

Because production of GC utilizes a byproduct of another chemical process, it affords a potentially low-cost replacement for EC and or PC, which are carbonate solvents typically used in lithium and lithium-ion batteries. In addition to cost, safety considerations (behavior under thermal abuse and overcharge conditions) have limited the widespread commercialization of lithium batteries for transportation applications. With its low vapor pressure, GC is far less flammable than EC and PC, and thus provides superior safety characteristics when used in lithium and lithium-ion cells.

As an added benefit, GC has a relatively wide potential window when used in lithium-ion cells, and desirably forms a solid electrolyte interphase (SEI) layer on graphite anodes under appropriate conditions. In addition, the GC is known to form oligomers under appropriate conditions and may form electrode passivation layers that improve cell longevity.

### BRIEF DESCRIPTION OF THE DRAWINGS

FIG. 1 is a plot of voltage versus capacity for the first two cycles of a graphite electrode in an electrolyte containing 1 M LiF₂BC₂O₄ in a 2:8 (weight/weight; w/w) mixture of commercial GC and EMC.

FIG. 2 is a plot of voltage versus capacity for the first cycle of a graphite electrode in an electrolyte containing 1 M LiPF₆ in a 2:8 (w/w) mixture of commercial GC and EMC.

FIG. 3 is a plot of voltage versus capacity for a graphite electrode in an electrolyte containing 1.2 M LiPF₆ in a 2:8 (w/w) mixture of dry, purified GC and DMC.

FIG. 4 is a plot of dQ/dV over a voltage range of 0.2 to 2.2 volts for a graphite electrode in an electrolyte containing 1.2 M LiPF₆ in a 2:8 (w/w) mixture of dry, purified GC and DMC, demonstrating SEI formation.

FIG. 5 is a plot of dQ/dV over a voltage range of 0 to 0.3 volts for a graphite electrode in an electrolyte containing 1.2 M LiPF₆ in a 2:8 (w/w) mixture of dry, purified GC and DMC, demonstrating lithium ion intercalation and deintercalation.

FIG. 6 is a plot of voltage versus capacity for a graphite electrode in an electrolyte containing 1.2 M LiPF₆ in a 1:1 (w/w) mixture of dry, purified GC and DMC.

FIG. 7 is a plot of voltage versus capacity for a graphite electrode in an electrolyte containing 1.2 M LiPF₆ in dry, purified GC.

FIG. 8 is a plot of voltage versus capacity for a graphite electrode in an electrolyte containing 1M LiBF₄ in a 2:8 (w/w) mixture of dry, purified GC and DMC.

FIG. 9 is a plot of dQ/dV over a voltage range of 0.2 to 2 volts for a graphite electrode in an electrolyte containing 1M LiBF₄ in a 2:8 (w/w) mixture of dry, purified GC and DMC, demonstrating SEI formation.

FIG. 10 is a plot of dQ/dV over a voltage range of 0 to 0.4 volts for a graphite electrode in an electrolyte containing 1M LiBF₄ in a 2:8 (w/w) mixture of dry, purified GC and DMC, demonstrating lithium ion intercalation and deintercalation.

FIG. 11 is a plot of voltage versus capacity for a graphite electrode in an electrolyte containing 1 M LiF₂BC₂O₄ in a 2:8 (w/w) mixture of dry, purified GC and DMC.

FIG. 12 is a plot of dQ/dV over a voltage range of 0.2 to 2 volts for a graphite electrode in an electrolyte containing 1 M LiF₂BC₂O₄ in a 2:8 (w/w) mixture of dry, purified GC and DMC, demonstrating SEI formation.

FIG. 13 is a plot of dQ/dV over a voltage range of 0 to 0.4 volts for a graphite electrode in an electrolyte containing 1M LiF₂BC₂O₄ in a 2:8 (w/w) mixture of dry, purified GC and DMC, demonstrating lithium ion intercalation and deintercalation.

FIG. 14 is a plot of voltage versus capacity for the first two cycles of an oxide electrode in an electrolyte containing 1.2 M LiPF₆ in a 2:8 (w/w) mixture of dry, purified GC and DMC.

FIG. 15 is a plot of dQ/dV over a voltage range of 3 to 4.4 volts for an oxide electrode in an electrolyte containing 1.2 M LiPF₆ in a 2:8 (w/w) mixture of dry, purified GC and DMC, demonstrating surface film formation on the oxide electrode.

FIG. 16 is a plot of voltage versus capacity for the first two cycles of an oxide electrode in an electrolyte containing 1M LiBF₄ in a 2:8 (w/w) mixture of dry, purified GC and DMC.

FIG. 17 is a plot of dQ/dV over a voltage range of 3 to 4.4 volts for an oxide electrode in an electrolyte containing 1M LiBF₄ in a 2:8 (w/w) mixture of dry, purified GC and DMC, demonstrating surface film formation on the oxide electrode.

FIG. 18 is a plot of voltage versus capacity for the first two cycles of an oxide (+) versus graphite (−) cell in an electrolyte containing 1.2 M LiPF₆ in a 2:8 (w/w) mixture of dry, purified GC and DMC.

FIG. 19 is a plot of voltage versus capacity for the first two cycles of an oxide (+) versus graphite (−) cell in an electrolyte containing 1 M LiBF₄ in a 2:8 (w/w) mixture of dry, purified GC and DMC.

FIG. 20 is a plot of capacity versus cycle number for oxide(+) versus graphite(−) cells with electrolytes containing various concentrations (0, 0.75, 1.5 and 3% (w/w)) dry, purified GC in 1.2 M LiPF₆ in 3:7 (w/w) EC:EMC.

FIG. 21 is a plot of normalized capacity versus cycle number for oxide (+) versus graphite (−) cells with electrolytes containing various concentrations (0, 0.75, 1.5 and 3% (w/w)) dry, purified GC in 1.2 M LiPF₆ in 3:7 (w/w) EC:EMC.

### DETAILED DESCRIPTION OF THE PRESENT INVENTION

The present invention provides an improved electrolyte composition for use in lithium and lithium ion batteries. The electrolyte composition comprises a lithium salt in a liquid carrier comprising glycerol carbonate. Glycerol carbonate is a relatively nontoxic solvent with very low vapor pressure and a significantly higher dielectric constant (about 109.7 at 25° C., about 111.5 at 20° C.) than other carbonate solvents used in lithium cell electrolytes (e.g., ethylene carbonate has a dielectric constant of about 90.5 at 40° C., while propylene carbonate and butylene carbonate have dielectric constants in the range of about 55 to 67 at 20 to 25° C.). The higher dielectric constant of GC affords better lithium solvation properties, i.e., GC enables the dissolution of larger quantities of Li salts that are typically used in lithium and lithium-ion batteries. In addition, GC does not freeze above room temperature, unlike the commonly used carbonate solvent EC. GC also has environmental advantages, since it is made from glycerol, which is an unwanted byproduct of biodiesel production. “Green” methods to make GC directly from glycerin with high efficiency have just recently been developed.

Lithium salts suitable for use in the present invention include any lithium salt that can be used in a lithium or lithium ion battery cell. Non-limiting examples of suitable lithium salts include LiPF₆, LiBF₄, LiF₂BC₂O₄, and LiB(C₂O₄)₂. The concentration of lithium salt in the electrolyte composition can be any concentration suitable for used as an electrolyte in a lithium or lithium ion cell. Preferably, the concentration of lithium salt in the carrier is in the range of about 0.1 molar (M) to about 5 molar, more preferably about 1 M to about 1.5 M (e.g., about 1.2 M).

In addition to glycerol carbonate, the liquid carrier can include other solvents used in lithium and lithium ion cell electrolyte compositions. Non-limiting examples of such addition solvents include ethylene carbonate, propylene carbonate, dimethylcarbonate, and ethylmethylcarbonate, as well as combinations of two or more such carbonates. In some preferred embodiments, the liquid carrier comprises GC and at least one other carbonate solvent wherein the weight ratio of GC-to-the at least one other carbonate solvent is in the range of about 1:100 to about 100:1. In other preferred embodiments, the liquid carrier comprises GC and at least one other carbonate solvent wherein the weight ratio of GC-to-the at least one other carbonate solvent is in the range of about 1:10 to about 10:1.

In one preferred embodiment, the liquid carrier composition comprises about 0.25 to about 5 percent by weight, preferably about 1 to 3% (e.g., about 1.5%) of GC in a mixture of ethylene carbonate and ethyl methyl carbonate. Preferably, the EC and EMC are present in a weight ratio in the range of about 1:4 (20% EC, 80% EMC) to about 2:3 (i.e., 1:1.5; 40% EC, 60% EMC). A particularly preferred mixture comprises about 1 to about 2% (w/w) GC in an approximately 3:7 (w/w) mixture of EC and EMC. The preferred lithium salt in such liquid carriers is about 1 to 1.5 M LiPF₆ (e.g., about 1.2 M).

The liquid carrier of the electrolyte composition can additionally include glycerol carbonate derivatives such as ethers and esters. If desired, the carrier can also include one or more additives to enhance the properties of the carrier. For example, a surface-reactive oxygen heterocycle, such as a dihydrofuran compound, an unsaturated cyclic carbonate compound, or a lactone compound, can be added to aid in the formation of a desirable solid electrolyte interphase (SEI) layer on the surface of a graphite anode.

The electrolyte compositions of the present invention are particularly useful in an electrochemical cell in combination with an anode and a cathode. A preferred anode comprises graphite. A preferred cathode comprises lithium or a lithium compound (e.g., a lithium-bearing layered oxide compound such as LiNi_{0.8}Co_{0.15}Al_{0.05}O₂). A battery of the present invention comprises a plurality of such electrochemical cells arranged in series, in parallel, or both.

The following non-limiting examples are provided to better illustrate certain aspects of the present invention.

### Example 1

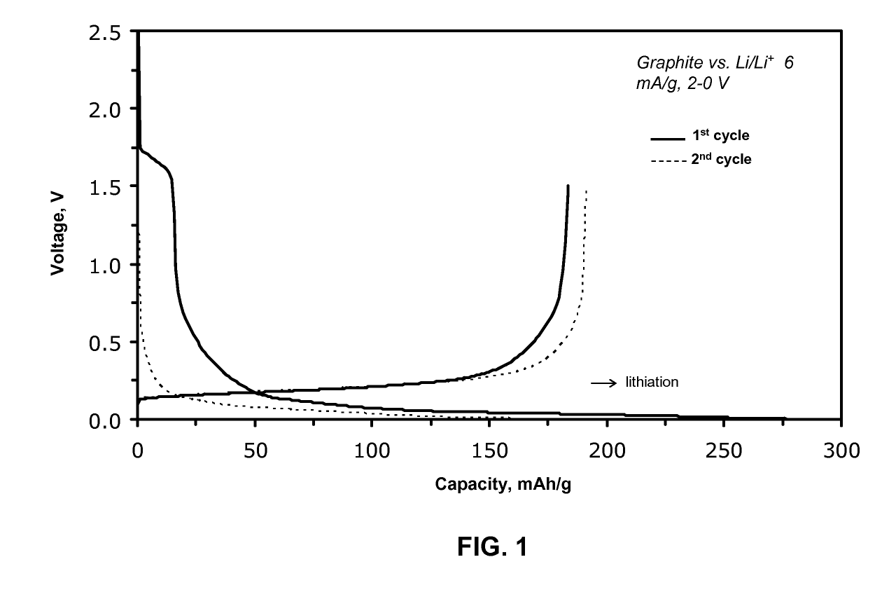

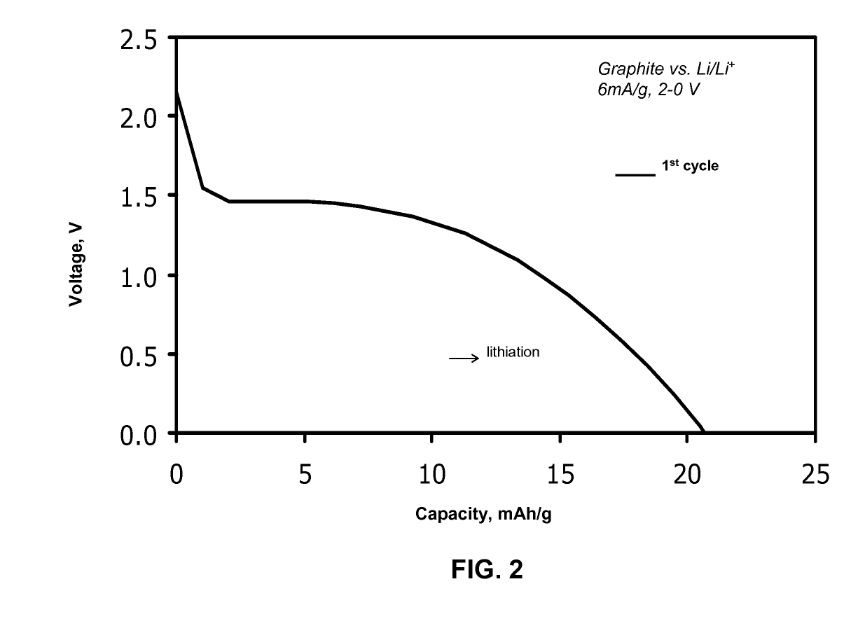

An electrolyte composition comprising 1 M LiF₂BC₂O₄ in a 2:8 (w/w) mixture of commercially-available GC and EMC was prepared. The GC was used as-received, and was about 93% pure and contained moisture, alcohols and other impurities. A graphite electrode was cycled in the presence of the electrolyte (charged and discharged twice; two cycles) over a voltage range of about 1.5 to 0 volts (V) at current of about 0.6 milliAmps per gram. The capacity (in mAh/g) of the graphite electrode was plotted as a function of the voltage in the graph provided in FIG. 1. The data in FIG. 1 demonstrate that the electrolyte composition was able to cycle, although the observed graphite capacity was less than the expected value of about 330 mAh/g. The irreversible loss observed in the first cycle in FIG. 1 was likely due, at least in part, to the known reduction of LiF₂BC₂O₄. The cycling data indicated that an SEI was forming during the first lithiation cycle. A graphite electrode was also cycled over the same voltage range in a similar electrolyte in which the 1 M LiF₂BC₂O₄ was replaced by 1 M LiPF₆. This electrolyte did not cycle well, as is evident in FIG. 2.

### Example 2

In order to improve the efficiency and cycling properties of the electrolyte, the GC was purified by contacting the solvent with vacuum dried molecular sieves (ACROS ORGANIC, 3A, 4 to 8 mesh), for about 12 hours under an argon (Ar) atmosphere, decanting, and repeating for another 12 hours. The molecular sieves were dried under vacuum at about 200° C. for about 14 hours before the process. The GC was then decanted again and vacuum filtered to obtain a dried, purified GC.

### Example 3

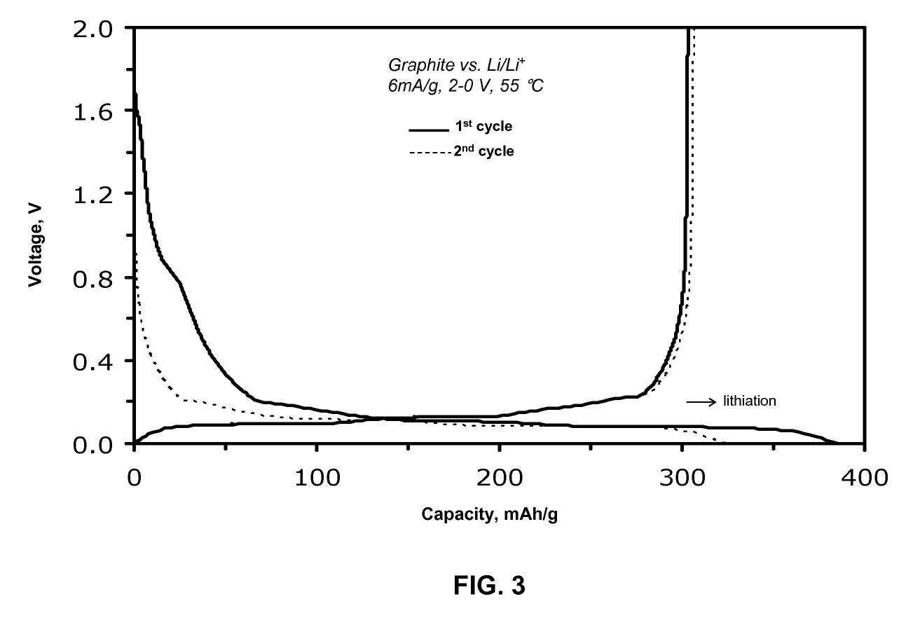

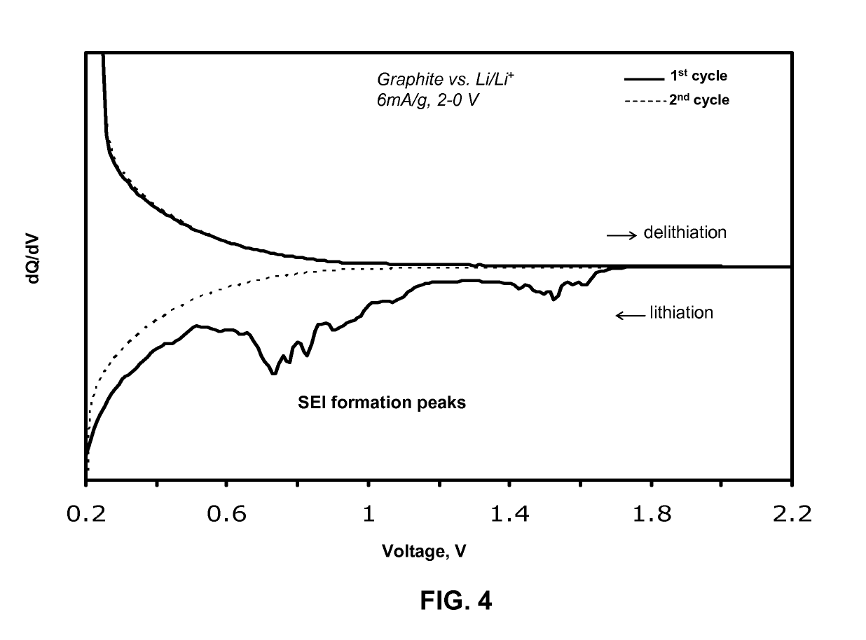

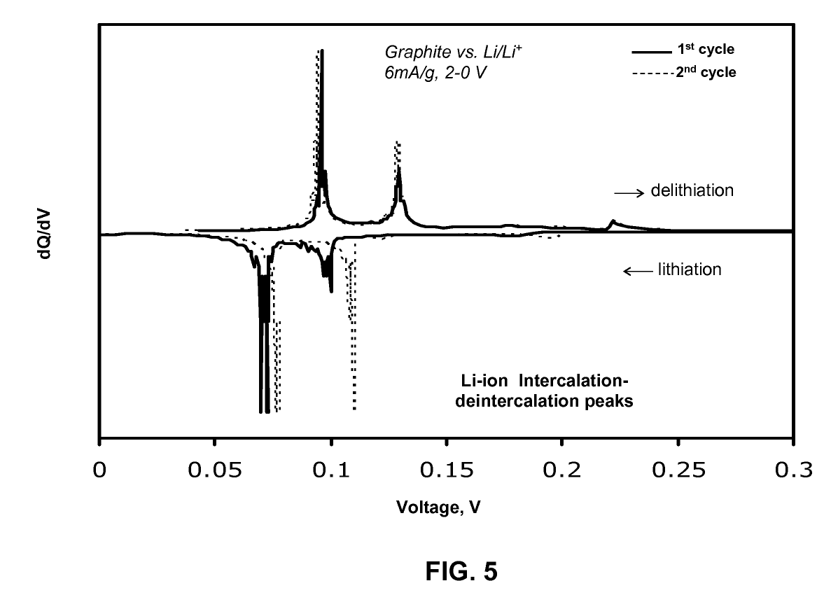

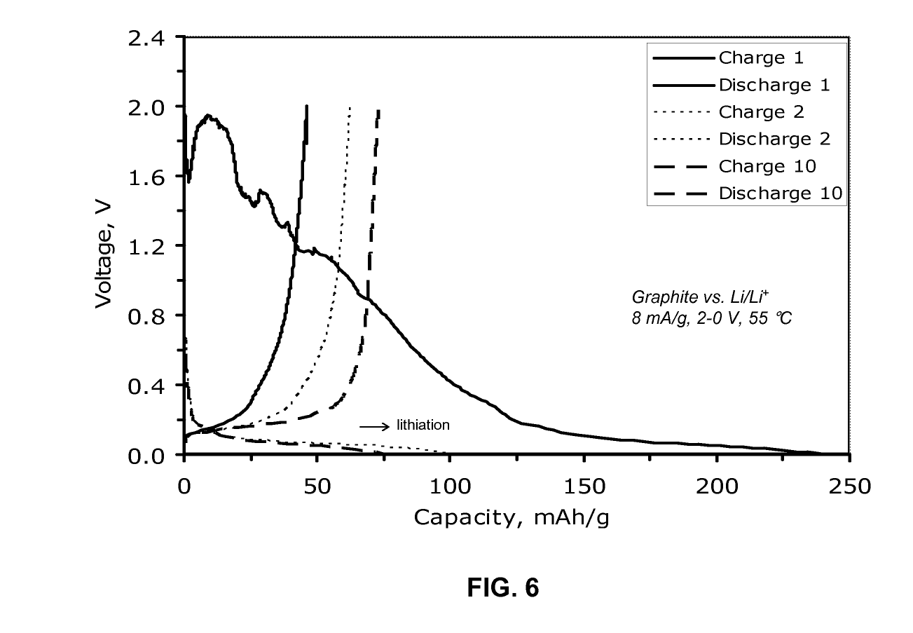

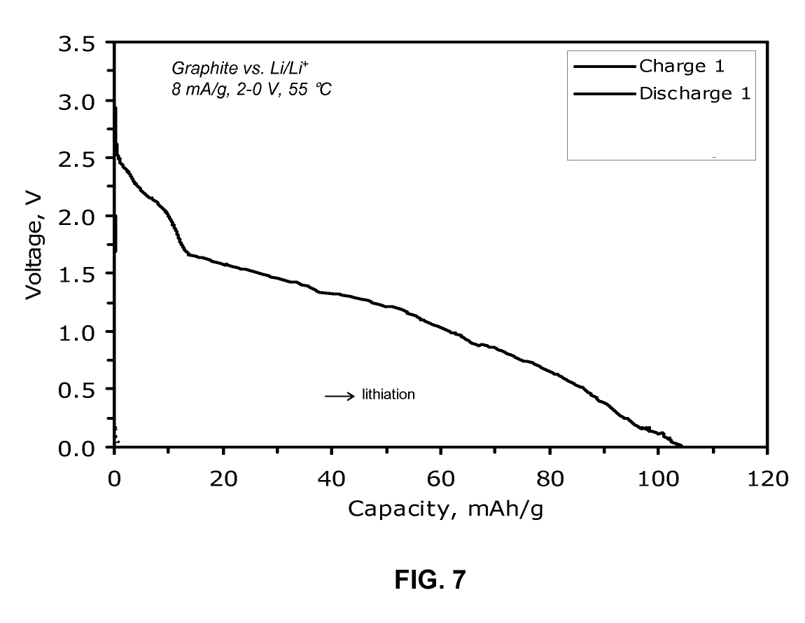

An electrolyte containing 1.2 M LiPF₆ in a 2:8 (w/w) mixture of the dry, purified GC from Example 2 and DMC was prepared. A graphite electrode was cycled with this electrolyte over a voltage range of about 2 to 0 V. FIG. 3 provides a graph of voltage versus capacity for the graphite electrode in this electrolyte. As is evident in FIG. 3, the electrode did cycle under these conditions. SEI formation on the graphite was evident (see FIG. 4), as well, which protected the graphite from lithium intercalation (see FIG. 5). A graphite electrode was also cycled over the same voltage range in an electrolyte containing 1.2 M LiPF₆ in a 1:1 (w/w) mixture of dry, purified GC and DMC. The data in FIG. 6 indicates that the graphite capacity is lower than expected for reasons that may include the following: (i) incomplete or insufficient SEI layer formation, (ii) inability of Li to intercalate into the graphite, etc. Although the graphite capacity increases with cycling, the lithiation capacity after 10 cycles is less than 100 mAh/g either because of partial graphite damage, graphite isolation, or other reasons that cause partial Li intercalation. The graphite electrode did not cycle well in an electrolyte containing 1.2 M LiPF₆ in a dry, purified GC solvent as is evident in FIG. 7. The capacity during the first lithiation cycle in FIG. 7 may be attributed to electrolyte reduction. Li ions did not intercalate into the graphite because of reasons that may include the following: (i) solvent intercalation destroys the graphite because of an incomplete or insufficient SEI layer, (ii) SEI layer creates isolation of graphite particles, (iii) solvated Li-ions cannot diffuse through SEI layer, etc.

### Example 4

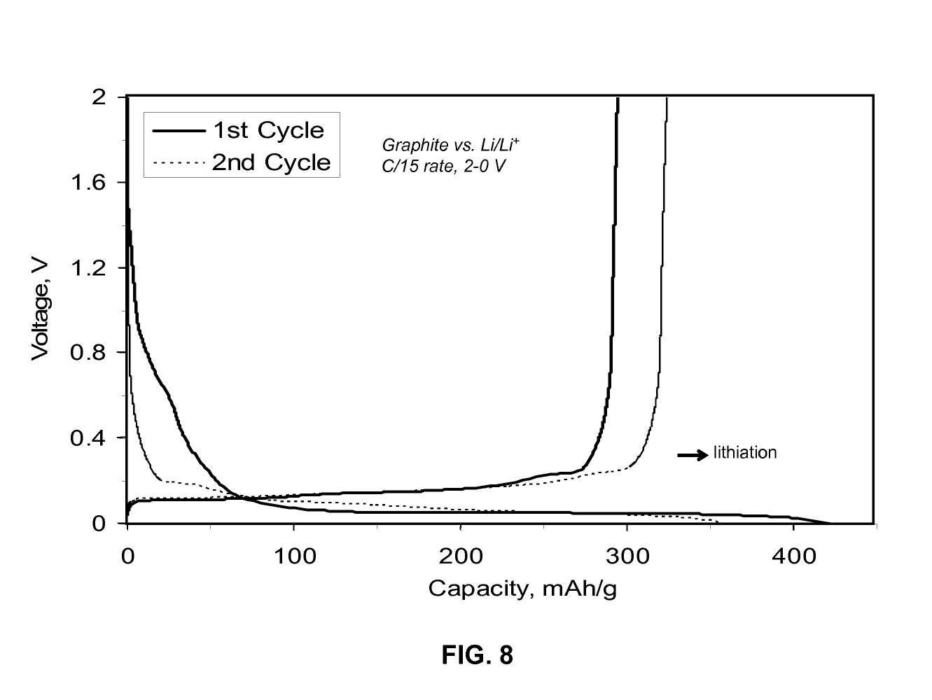

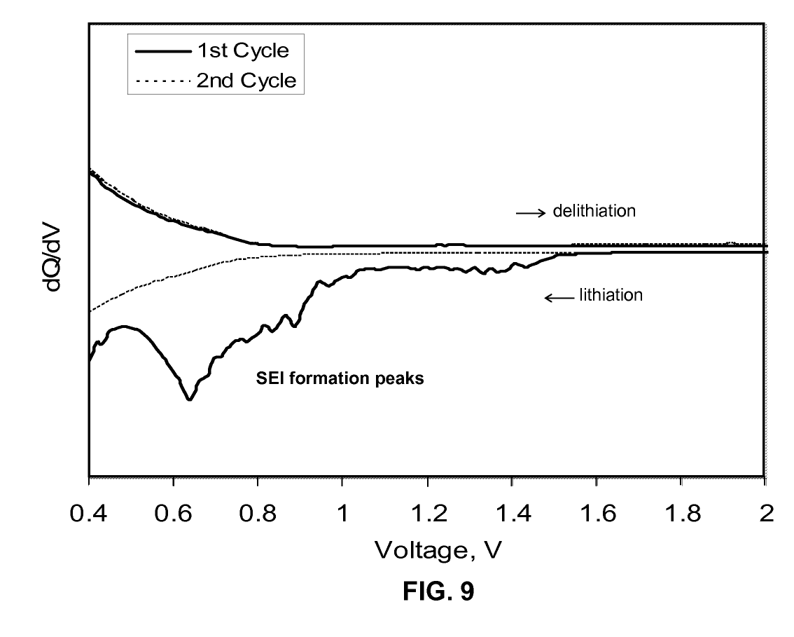

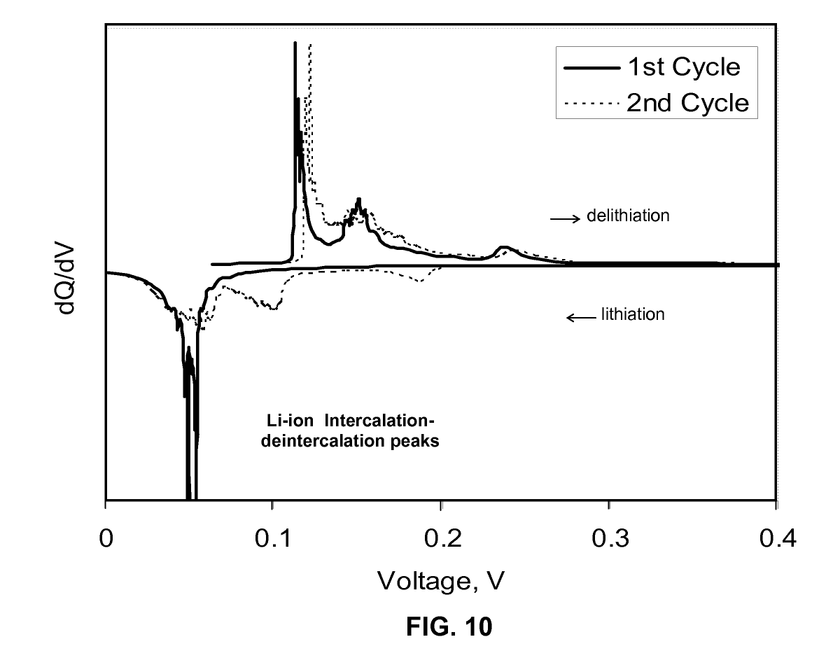

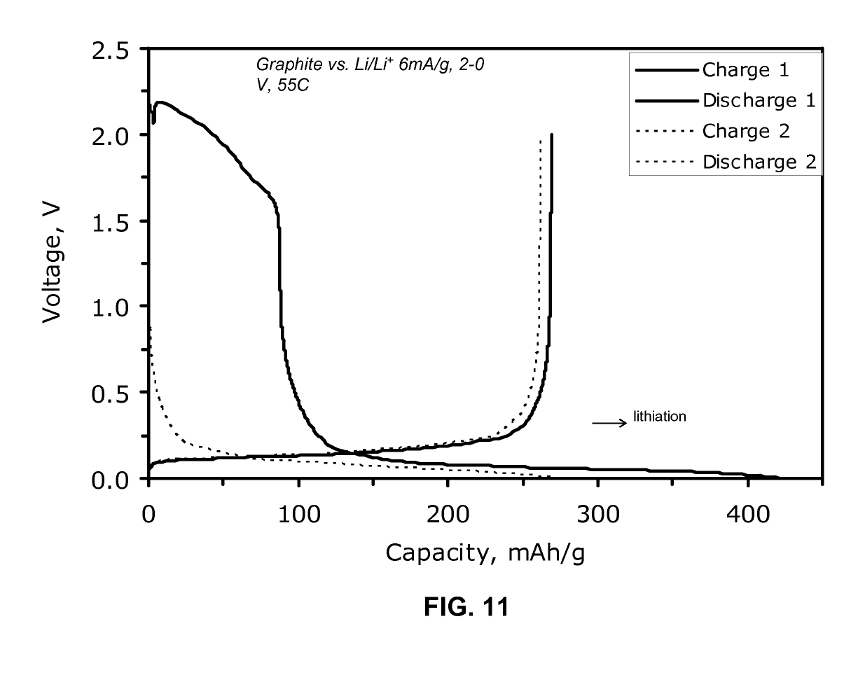

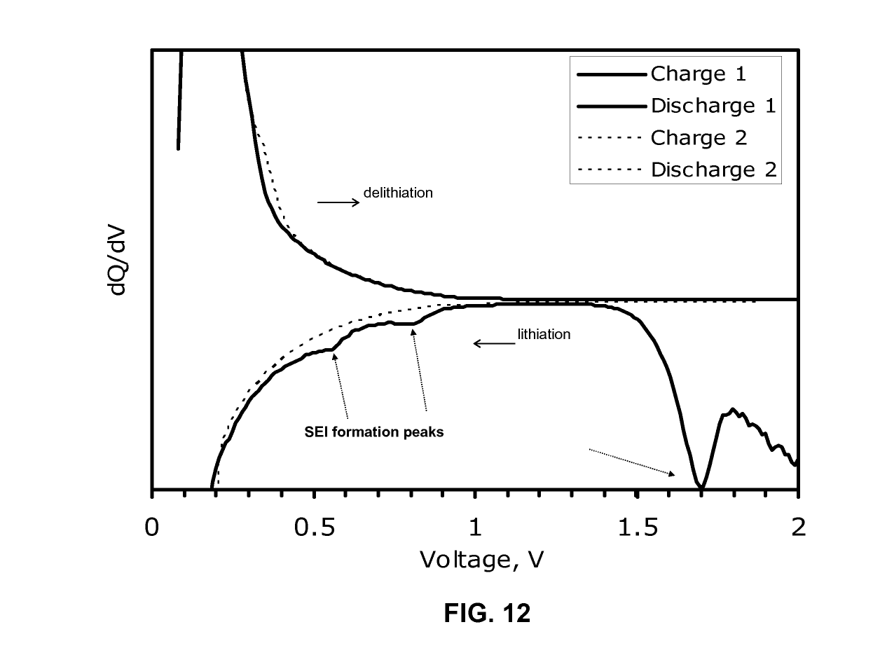

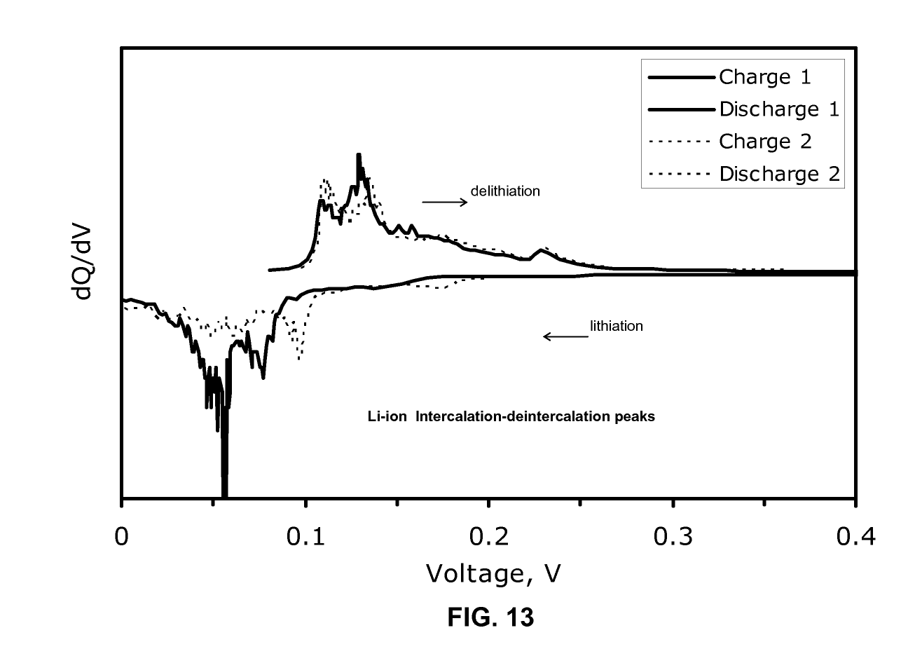

An electrolyte containing 1 M LiBF₄ in a 2:8 (w/w) mixture of the dry, purified GC from Example 2 and DMC was prepared. A graphite electrode was cycled with this electrolyte over a voltage range of about 2 to 0 V. FIG. 8 provides a graph of voltage versus capacity for the graphite electrode in this electrolyte. As is evident in FIG. 8, the electrode did cycle under these conditions. SEI formation on the graphite was evident (see FIG. 9), as well, which protected the graphite from lithium intercalation (see FIG. 10). A graphite electrode was also cycled over the same voltage range in a similar electrolyte in which the 1 M LiBF₄ was replaced by 1 M LiF₂BC₂O₄. FIG. 11 provides a graph of voltage versus capacity for the graphite electrode in this electrolyte. As is evident in FIG. 11, the electrode did cycle under these conditions. SEI formation on the graphite was evident (see FIG. 12), as well, which protected the graphite from lithium intercalation (see FIG. 13). However, the graphite electrode capacities were lower than expected for reasons that may include the following: (i) SEI layer creates isolation of graphite particles, (ii) partial destruction of graphite particles, (iii) solvated Li-ions cannot diffuse through SEI layer, etc.

### Example 5

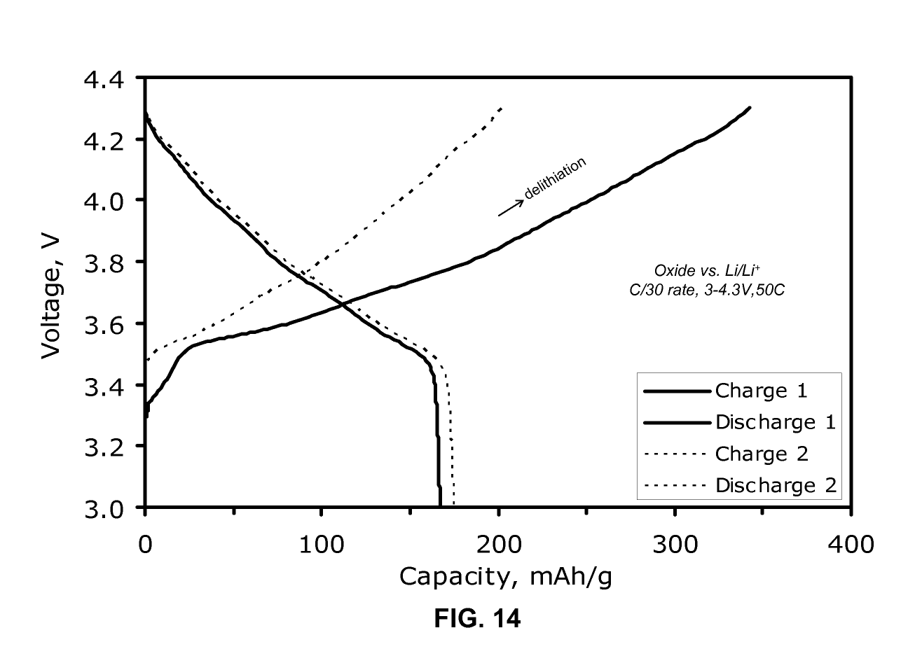

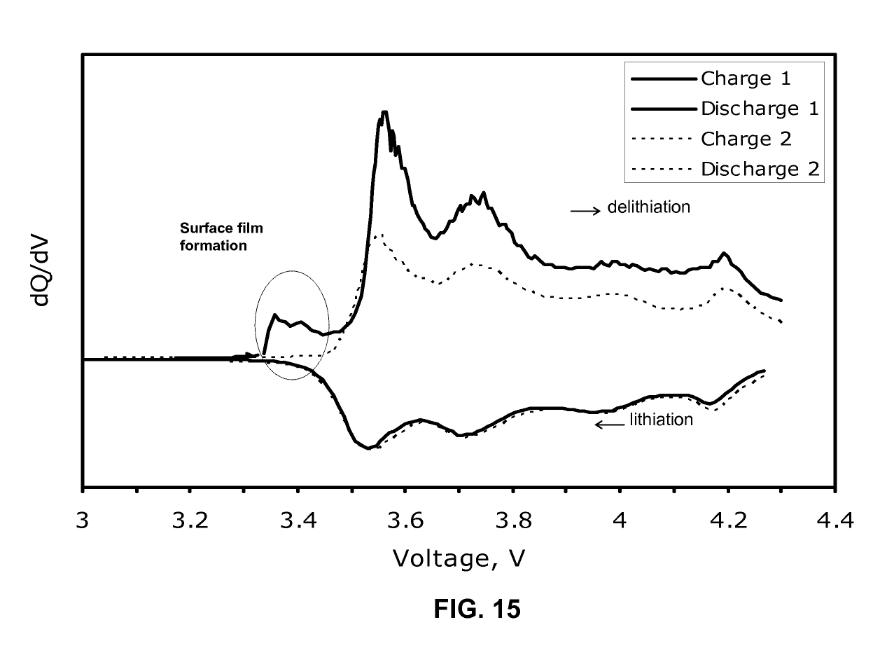

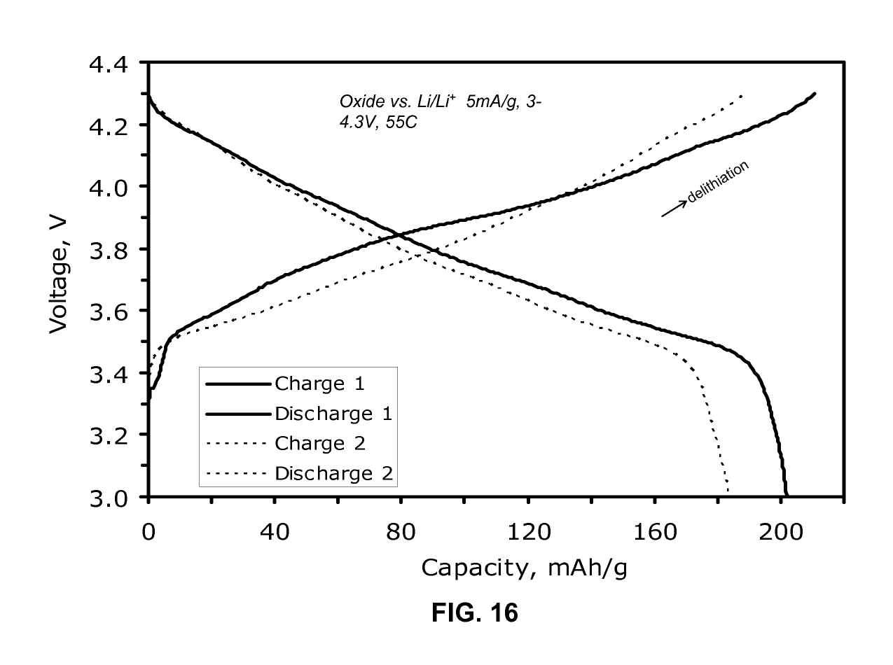

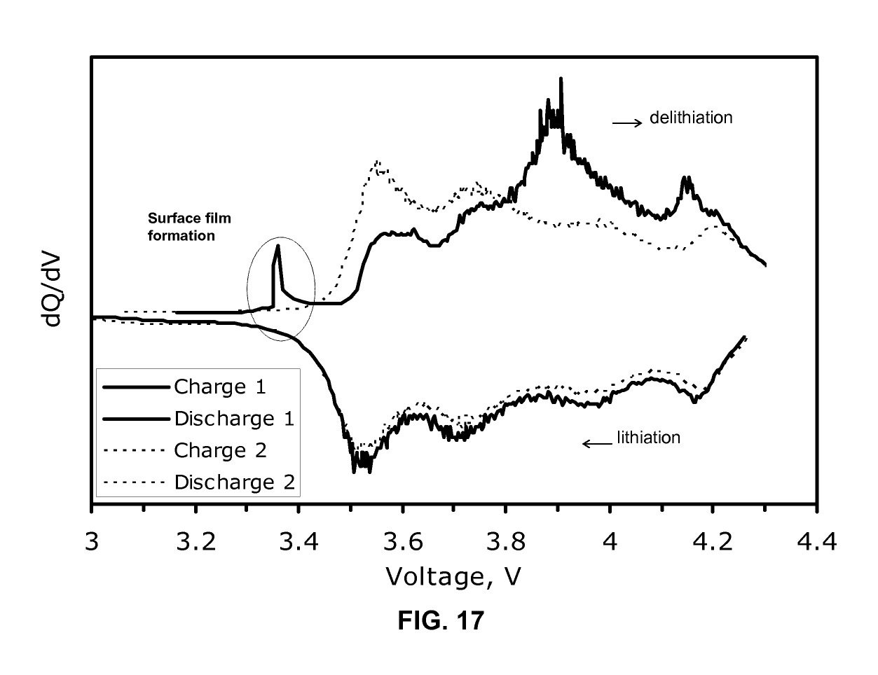

An electrode containing LiNi_{0.8}Co_{0.15}Al_{0.05}O₂ as the active component was evaluated in an electrolyte containing 1.2 M LiPF₆ in a 2:8 (w/w) mixture of dry, purified GC and DMC. FIG. 14 provides a graph of voltage versus capacity for the oxide electrode/electrolyte combination over a voltage range of about 3 to about 4.3 V. The data in FIG. 14 indicate that lithium was consumed during the first charge cycle to form a surface film on the oxide electrode (see FIG. 15). The data indicate that the GC oxidizes during the first cycle, but not in subsequent cycles. The data in FIG. 14 indicate that the oxide electrode delivers the expected capacity during the discharge cycle. The oxide electrode was also evaluated in an electrolyte containing 1.2 M LiBF₄ in a 2:8 (w/w) mixture of dry, purified GC and DMC. FIG. 16 provides a graph of voltage versus capacity for the oxide electrode/electrolyte combination over a voltage range of about 3 to about 4.3 V. The data in FIG. 16 indicate that lithium was consumed during the first charge cycle to form a surface film on the oxide electrode (see FIG. 17). The data indicate that the GC oxidizes during the first cycle, but not in subsequent cycles.

### Example 6

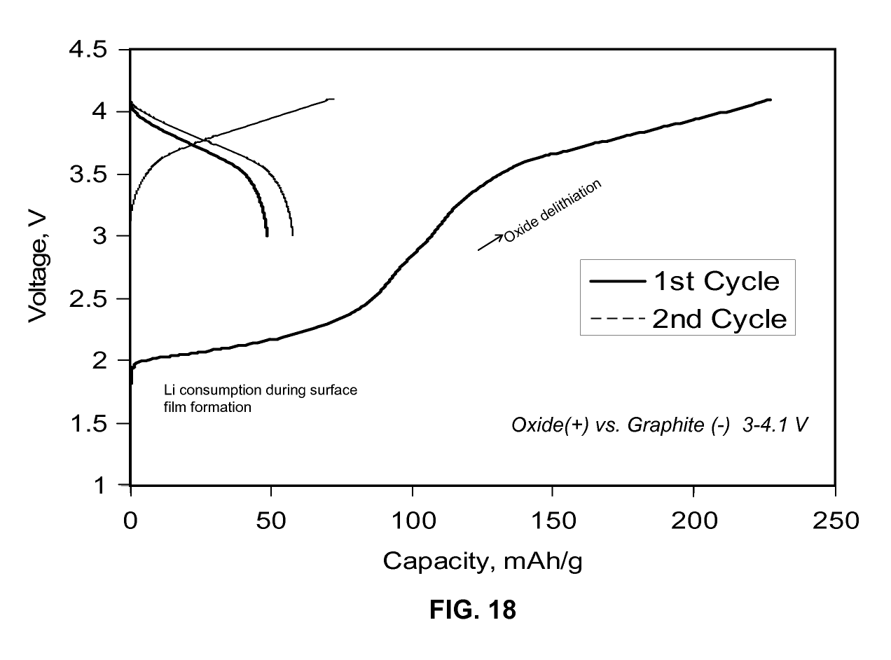

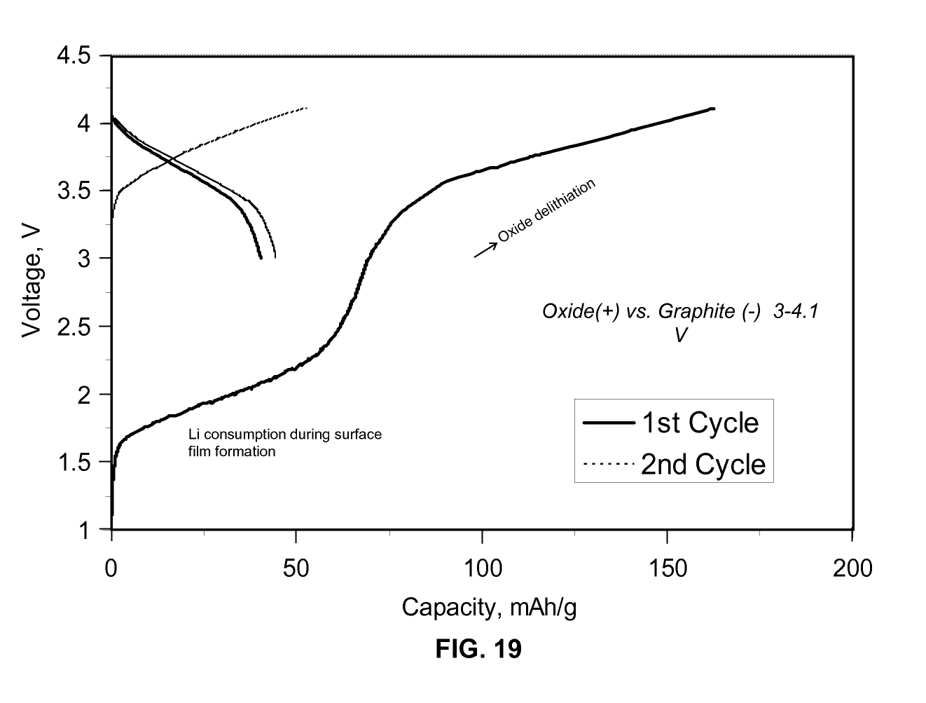

The full cell cycling behavior for a LiNi_{0.8}Co_{0.15}Al_{0.05}O₂//graphite cell utilizing the 1.2 M LiPF₆ in 2:8 (w/w) GC:DMC electrolyte also exhibited some lithium consumption (see FIG. 18) when cycled between about 3 and 4.1 volts. Similar behavior was observed for a LiNi_{0.8}Co_{0.15}Al_{0.05}O₂//graphite cell utilizing the 1 M LiBF₄ in 2:8 (w/w) GC:DMC electrolyte. The data in FIG. 19 indicate lithium consumption during the first cycle when the cell was cycled between about 3 and 4.1 volts.

### Example 7

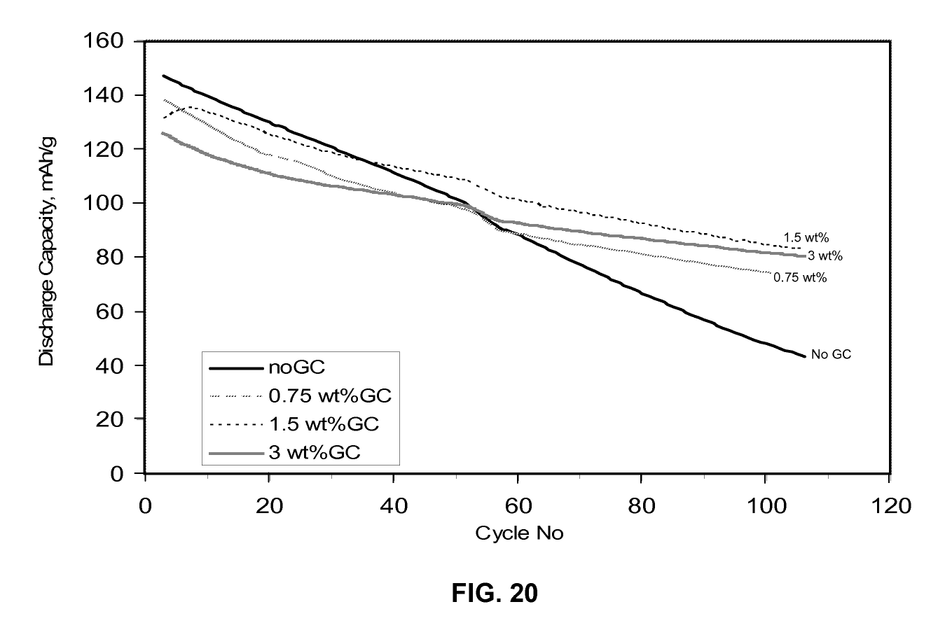

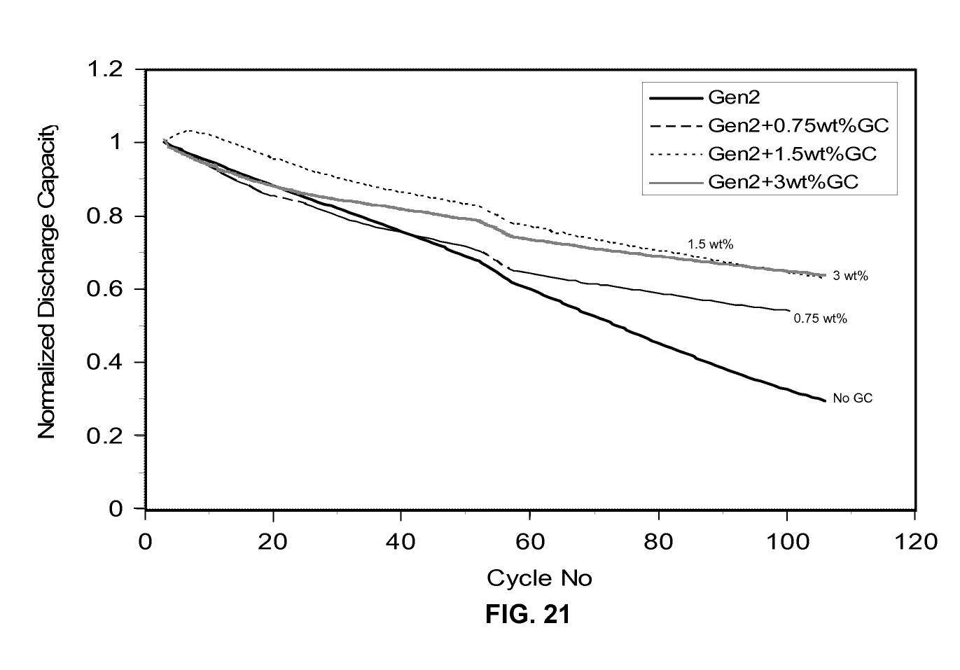

A series of electrolytes compositions containing 1.2 M LiPF₆ in 3:7 (w/w) EC:EMC with 0, 0.75, 1.5, and 3% (w/w) of the dry, purified GC of Example 2 was prepared. FIG. 20 provides full cell cycling data for these electrolytes in LiNi_{0.8}Co_{0.15}Al_{0.05}O₂//graphite cells cycled over a voltage range of about 3 to 4.1 volts. The presence of GC afforded a lower starting capacity, but surprisingly better overall cycling performance. The cell containing 1.5% (w/w) GC exhibited the best cycling performance (i.e., highest capacity and lowest impedance) after 100 cycles at about 55° C. FIG. 21 provides a graph of normalized capacity versus cycle number, which demonstrates that capacity fade is the highest for a cell with no GC, and lowest for the 1.5% (w/w) GC cell after 100 cycles at about 55° C. In FIG. 21, the designation “Gen 2” refers to 1.2 M LiPF₆ in 3:7 (w/w) EC:EMC.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. An electrolyte for lithium and lithium-ion batteries comprising a lithium salt in a liquid carrier comprising glycerol carbonate.

2. The electrolyte of claim 1 wherein the lithium salt comprises LiF₂BC₂O₄.

3. The electrolyte of claim 1 wherein the lithium salt comprises LiPF₆.

4. The electrolyte of claim 1 wherein the lithium salt comprises LiBF₄.

5. The electrolyte of claim 1 wherein the lithium salt comprises LiB(C₂O₄)₂.

6. The electrolyte of claim 1 wherein the lithium salt is present at a concentration in the range of about 0.1 to about 5 M.

7. The electrolyte of claim 1 wherein the lithium salt is present at a concentration in the range of about 1 to about 1.5 M.

8. The electrolyte of claim 1 wherein the liquid carrier also comprises at least one carbonate selected from the group consisting of ethylene carbonate, propylene carbonate dimethylcarbonate, and ethylmethylcarbonate.

9. The electrolyte of claim 1 wherein the liquid carrier comprises glycerol carbonate and at least one other carbonate solvent wherein the weight ratio of glycerol carbonate-to-the at least one other carbonate solvent is in the range of about 1:100 to about 100:1.

10. The electrolyte of claim 1 wherein the liquid carrier comprises glycerol carbonate and at least one other carbonate solvent wherein the weight ratio of glycerol carbonate-to-the at least one other carbonate solvent is in the range of about 1:10 to about 10:1.

11. The electrolyte of claim 1 wherein the liquid carrier also comprises a glycerol carbonate ether, a glycerol carbonate ester, or a combination thereof.

12. The electrolyte of claim 1 wherein the liquid carrier also comprises an electrode surface-reactive oxygen heterocycle.

13. The electrolyte of claim 12 wherein the electrode surface-reactive oxygen heterocycle comprises at least one material selected from the group consisting of a dihydrofuran, an unsaturated cyclic carbonate and a lactone.

14. An electrolyte for lithium and lithium-ion batteries comprising a lithium salt in a liquid carrier comprising about 0.25 to about 5 percent by weight glycerol carbonate in a mixture of ethylene carbonate (EC) and ethylmethylcarbonate (EMC).

15. The electrolyte of claim 14 wherein the GC is present at a concentration in the range of about 1 to about 3 percent by weight.

16. The electrolyte of claim 15 wherein the EC and EMC are present in an EC:EMC weight ratio in the range of about 1:1.5 to about 1:4.

17. The electrolyte of claim 16 wherein the lithium salt comprises about 1 to about 1.5 M LiPF₆.

18. An electrolyte for lithium and lithium-ion batteries comprising about 1 to about 1.5 M LiPF₆ in a liquid carrier comprising about 1 to about 3 percent by weight glycerol carbonate in a mixture of ethylene carbonate (EC) and ethylmethylcarbonate (EMC), wherein the EC and EMC are present in an EC:EMC weight ratio in the range of about 1:1.5 to about 1:4.

19. An electrochemical cell comprising an anode, a cathode, and an electrolyte of claim 1 in contact with the anode and the cathode.

20. The electrochemical cell of claim 19 wherein the anode comprises graphite and the cathode comprises lithium or a lithium oxide compound.

21. A battery comprising a plurality of electrochemical cells of claim 19 arranged in series, in parallel, or both.
